(19) United States
(12) Patent Application Publication
(10) Pub. No.: US 2026/0361055 A1
(43) Pub. Date: Nov. 12, 2026

(54) SPARK PLUG

(71) Applicant: Niterra Co., Ltd., Nagoya-shi, Aichi (JP)

(72) Inventors: Kaito NAKAMURA, Nagoya-shi, Aichi (JP); Kengo HATTORI, Nagoya-shi, Aichi (JP); Hiroaki IZAWA, Nagoya-shi, Aichi (JP); Tomokatsu KASHIMA, Nagoya-shi, Aichi (JP); Daisuke MIYATA, Nagoya-shi, Aichi (JP)

(73) Assignee: Niterra Co., Ltd., Nagoya-shi, Aichi (JP)

(21) Appl. No.: 19/123,961

(22) PCT Filed: Feb. 20, 2024
(86) PCT No.: PCT/JP2024/006033

§ 371 Date: Apr. 24, 2025

(30) Foreign Application Priority Data
Apr. 18, 2023 (JP) 2023-067565

(51) Int. Cl. H01T 13/39; C22C 5/04

(52) U.S. Cl. CPC H01T 13/39; C22C 5/04

(57) ABSTRACT

A spark plug includes a first electrode which has a discharge member joined to a base member containing Ni as a main component by the mediation of a fusion zone, and a second electrode facing the discharge member with a spark gap therebetween. The discharge member contains Ru as a main component, and a value obtained by dividing Vickers hardness of the fusion zone by Vickers hardness of the discharge member is 0.25 or greater and 2.8 or smaller.

### FIELD OF THE INVENTION

The present invention relates to a spark plug having a discharge member containing Ru.

### BACKGROUND OF THE INVENTION

JP2013-512551A discloses, as a related technique, a spark plug which Includes a first electrode having a discharge member, and a second electrode facing the discharge member with a spark gap therebetween, wherein the material of the discharge member is a metallic material containing Ru as a main component.

Since the crystal structure type of Ru is a hexagonal close-packed lattice, Ru is high in resistance to dislocation caused by external force and does not deform easily. Therefore, the related technique has a problem that the discharge member containing Ru as a main component is prone to crack.

The present invention has been accomplished so as to solve the aforementioned problem, and an object of the present invention is to provide a spark plug in which cracking of the discharge member is mitigated.

### SUMMARY OF THE INVENTION

In a first aspect of the present invention so as to attain the aforementioned object, there is provided a spark plug including a first electrode which has a discharge member joined to a base member containing Ni as a main component by the mediation of a fusion zone, and a second electrode facing the discharge member with a spark gap therebetween. The discharge member contains Ru as a main component, and a value obtained by dividing Vickers hardness of the fusion zone by Vickers hardness of the discharge member is 0.25 or greater and 2.8 or smaller.

A second aspect is directed to a specific embodiment of the first aspect, in which the discharge member contains one or more elements selected from the group consisting of Ir, Pt, Rh, Re, Pd, Mo, W, Au, Al, Co, Ni, Cr, and Si.

A third aspect is directed to a specific embodiment of the first aspect, in which the ratio of Vickers hardness of the fusion zone to Vickers hardness of the discharge member is 1.05 or greater and 2.8 or smaller.

A fourth aspect is directed to a specific embodiment of the third aspect, in which the discharge member contains one or more elements selected from the group consisting of Ir, Pt, Rh, Re, Pd, Mo, and W.

According to the present invention, the value obtained by dividing Vickers hardness of the fusion zone by Vickers hardness of the discharge member is 0.25 or greater and 2.8 or smaller, in which the fusion zone achieves joining of the discharge member contains Ru as a main component to the base member containing Ni as a main component. Thus, deformation of the fusion zone reduces deformation of the discharge member, to thereby mitigate cracking of the discharge member.

### BRIEF DESCRIPTION OF THE DRAWINGS

FIG. 1 Illustrates an example view of a spark plug in one embodiment which is sectioned on one side.

FIG. 2 illustrates an example view of a portion of the spark plug which is indicated by II in FIG. 1 and is sectioned on one side.

### DETAILED DESCRIPTION OF THE INVENTION

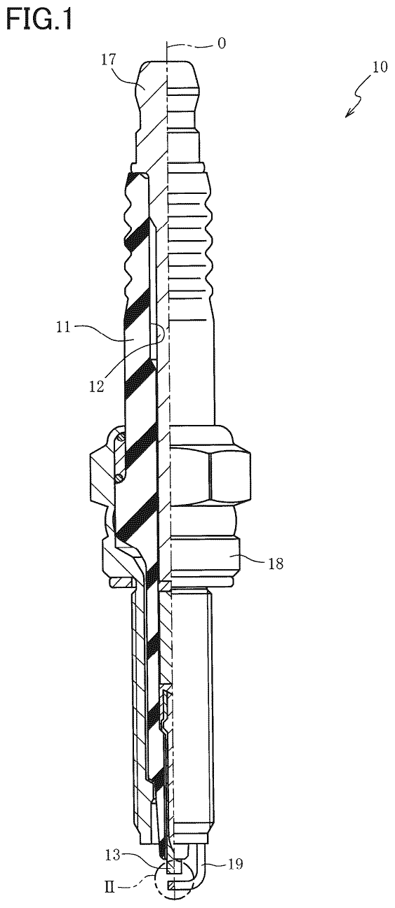

A preferred embodiment of the present invention will now be described with reference to the attached drawing. FIG. 1 is a view of a spark plug 10 in one embodiment which is sectioned on one side of an axial line O. In FIG. 1, the lower side of the sheet will be referred to as the forward end side of the spark plug 10, and the upper side of the sheet will be referred to as the rear end side of the spark plug 10.

As shown in FIG. 1, the spark plug 10 includes a center electrode 13 (first electrode) and a ground electrode 19 (second electrode). An insulator 11 insulates the center electrode 13 and the ground electrode 19 from each other. The ground electrode 19 is connected to a metallic shell 18. The insulator 11 is a generally cylindrical member formed of a ceramic material (e.g., alumina) which is excellent in mechanical characteristics and insulation performance at high temperatures. The insulator 11 has an axial hole 12 which penetrates the insulator 11 along the axial line O. The center electrode 13 (first electrode) is a rod-shaped conductor disposed in the axial hole 12 to extends along the axial line O.

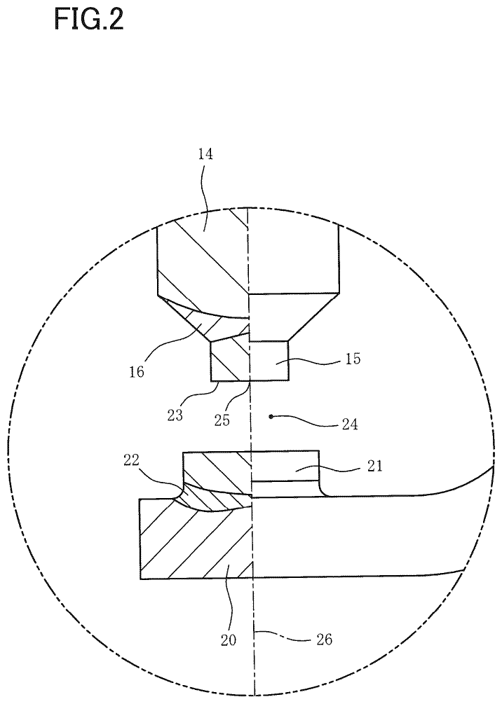

FIG. 2 is an enlarged view of a portion of the spark plug 10 which is indicated by II in FIG. 1 and is sectioned on one side. The center electrode 13 includes a base member 14, a discharge member 15 provided at the forward end of the base member 14, and a fusion zone 16 formed as a result of melting of the base member 14 and the discharge member 15. The base member 14 has a core which is excellent in heat conductivity and is embedded therein. The material of the base member 14 is a metallic material containing Ni as a main component. The material of the core is, for example, Cu or a Cu-base alloy. The core may be omitted. The expression “the material of the base member 14 is a metallic material containing Ni as a main component” means that Ni accounts for 50 mass % or more of the total mass of the metallic material.

The material of the discharge member 15 is a metallic material containing Ru as a main component. The expression “the discharge member is a metallic material containing Ru as a main component” means the ratio of the mass of Ru to the mass of the discharge member 15 is 50% or higher. In the present embodiment, the discharge member 15 has a disk-like shape. The discharge member 15 is fixed to the base member 14 via the fusion zone 16 formed through laser welding, resistance welding, or the like.

Referring back to FIG. 1, a metallic terminal member 17 is a rod-shaped conductor to which an ignition system (not shown) is connected, and its forward end side portion is disposed in the axial hole 12 of the insulator 11. The metallic terminal member 17 is electrically connected to the center electrode 13 within the axial hole 12.

The metallic shell 18 is a generally cylindrical member fixed to a threaded plug hole of an internal combustion engine (not shown). The material of the metallic shell 18 is a metallic material (e.g., low-carbon steel or the like) having electrical conductivity. The metallic shell 18 is fixed to the outer periphery of the insulator 11. The ground electrode 19 (second electrode). which is a rod-shaped conductor, is connected to the metallic shell 18. The ground electrode 19 is bent to extend from the metallic shell 18 toward the axial line O.

As shown in FIG. 2, the ground electrode 19 includes a base member 20 connected to the metallic shell 18, a discharge member 21 provided on the base member 20, and a fusion zone 22 formed as a result of melting of the base member 20 and the discharge member 21. A core which is excellent in heat conductivity is embedded in the base member 20. The material of the base member 20 is, for example, an Ni-base alloy, and the material of the core is Cu or a Cu-base alloy. The core may be omitted.

Examples of the material of the discharge member 21 includes a noble metal (e.g., Pt, Ir, Ru, Rh) having a resistance to spark consumption higher than that of the base member 20, W, and a noble meal-base or a W-base alloy. The discharge member 21 is fixed to the base member 20 via the fusion zone 22 formed through laser welding, resistance welding, or the like. The discharge member 15 of the center electrode 13 has a discharge surface 23 which faces toward the forward end side, and the discharge surface 23 faces the ground electrode 19 with a spark gap 24 therebetween.

The spark plug 10 is manufactured by, for example, a method described below. First, the center electrode 13 is inserted into the axial hole 12 of the insulator 11. Subsequently, the metallic terminal member 17 is inserted into the axial hole 12, and electrical continuity is established between the metallic terminal member 17 and the center electrode 13. Subsequently, the metallic shell 18 with the ground electrode 19 connected thereto beforehand is attached to the outer periphery of the insulator 11. The ground electrode 19 is bent such that the spark gap 24 is defined between the center electrode 13 and the discharge member 21 of the ground electrode 19, whereby the spark plug 10 is obtained.

The center electrode 13 has a value obtained by dividing Vickers hardness M of the fusion zone 16 by Vickers hardness D of the discharge member 15 (i.e., M/D) of 0.25 or greater and 2.8 or smaller. The test surface employed in measuring Vickers hardness values M, D is a surface obtained by polishing a cross-section including a straight line 26 passing through the center 25 of a discharge surface 23 of the discharge member 15 (i.e., a straight line 26 orthogonal to the discharge surface 23). The center 25 of the discharge surface 23 is a geometric center calculated by known means, assuming that discharge surface 23 is a plane figure.

Vickers hardness is determined, on the basis of JIS Z2244-1:2020, through dividing test force applied to an indenter which is pressed to the test surface by a surface area of indentation provided on the test surface by means of the indenter. In consideration of variation, the Vickers hardness of the fusion zone 16 is obtained by averaging the Vickers hardness values at 30 points selected at random in the test surface of the fusion zone 16, and the Vickers hardness of the discharge member 15 is obtained by averaging the Vickers hardness values at 30 points selected at random in the test surface of the discharge member 15.

The discharge member 15 is produced by a method (sintering method) of compacting powder containing Ru and sintering the resultant green body at a high temperature. The sintering method makes it possible to increase or decrease the Vickers hardness of the discharge member 15 by changing the temperature and pressure for sintering. The sintering method makes it possible to form the discharge member 15 into any shape such as a disc, a truncated cone, an elliptical prism, or a polygonal prism (a triangular prism, a quadrangular prism, or the like).

The discharge member 15 may also be produced by performing plastic working on an ingot of a metallic material containing Ru. Examples of the plastic working include hot or cold forging, rolling, swaging, punching, and wire drawing. Plastic working enables adjustment of the Vickers hardness of the discharge member 15 by processing distortion (hardening by processing) and miniaturization of crystal grains.

The fusion zone 16 is formed by laser welding. Laser welding makes it possible to change the ratio of the base member 14 and the discharge member 15 in the fusion zone 16, by changing the lase output and the irradiation position of a laser beam, thereby increasing or decreasing the Vickers hardness of the fusion zone 16. The fusion zone 16 may be formed by resistance welding. Resistance welding enables adjustment of the Vickers hardness of the fusion zone 16 by changing welding current, energization time, applied pressure, etc.

Since the crystal structure type of Ru is a hexagonal close-packed lattice, considerable resistance to dislocation caused by external force is achieved, whereby deformation of the object containing Ru is prevented. Thus, the discharge member 15 containing Ru as a main component is easy to crack, which is problematic. When the value obtained by dividing Vickers hardness M of the fusion zone 16 by Vickers hardness D of the discharge member 15 (i.e., M/D) is adjusted to be 0.25 or greater and 2.8 or smaller, deformation of the fusion zone 16 reduces deformation of the discharge member 15, to thereby mitigate cracking of the discharge member 15 jointed to the base member 14 by the mediation of the fusion zone 16.

The Vickers hardness of the fusion zone 16 is preferably 100 HV or higher and 650 HV or lower, more preferably 120 HV or higher and 630 HV or lower. These conditions are set for securing tensile strength and toughness of the fusion zones 16, 22, in order to mitigate cracking of the discharge member 15.

The Vickers hardness of the discharge member 15 is preferably 180 HV or higher and 550 HV or lower, more preferably 200 HV or higher and 530 HV or lower. These conditions are set for securing tensile strength and toughness of the discharge member 15.

Preferably, the discharge member 15 contains, in addition to Ru, one or more elements selected from the group consisting of Ir, Pt, Rh, Re, Pd, Mo, W, Au, Al, Co, Ni, Cr, and Si. These additional elements have an atomic radius of 111 pm or more and 144 pm or less, the range being approximate to the atomic radius of Ru (i.e., 134 pm). The additional element(s) is (are) incorporated, since the fusion zone 16 in which the base member 14 and the discharge member 15 are solved to form a solid solution, leading to enhancement in mechanical strength of the fusion zone 16.

More preferably, the discharge member 15 contains, in addition to Ru, one or more elements selected from the group consisting of Ir, Pt, Rh, Re, Pd, Mo, and W. The additional element(s) is (are) incorporated, since these additional elements have an atomic radius of 130 pm or more and 139 pm or less, the range being more approximate to the atomic radius of Ru (i.e., 134 μm), whereby the mechanical strength of the fusion zone 16 can be further enhanced through formation of solid solution.

The discharge member 21 may further contain, in addition to Ru, a metal oxide such as Y₂O₃ or Al₂O₃. The oxide content is, for example, 8 mass % or less. The total amount of the additional element(s) (excluding impurity) other than Ru or the amount of such oxides in the discharge member 21 is preferably 40 mass % or less, for the purpose of preventing a drop in melting point of the discharge member 21. Examples of the impurity include Na, K, Fe, Sn, Mn, Cu, Ag, and Th. The impurity content of the discharge member 21 is, for example, less than 1 mass %.

### EXAMPLES

The present invention will next be described in more detail by way of example, which should not be construed as limiting the invention thereto.

### (Fabrication of Discharge Member)

Testers conducted the following procedure. Each of the mixtures of a metal such as Ru, Ir, or Rh and Y₂O₃ having various compositional proportions was melted in vacuum, and subjected to inert gas atomization, to thereby yield powders having different Ru contents. Each powder was placed in a metal mold and pressed, to thereby form a columnar compact. The compact was heated at about 2,000 °C in a reducing atmosphere for sintering. By modulating the temperature or time of heating, various discharge members having different Vickers hardness values are yielded. Each discharge member was a columnar member having a bottom surface diameter of 0.6 mm and a height of 0.55 mm. The density of each discharge member was 95% or higher as determined through the Archimedes method. The chemical composition of each discharge member was determined by means of a wavelength dispersive type X-ray spectrometer (WDS). The measurement conditions included an acceleration voltage of 20 KV, a beam diameter of 20 μm, and a measuring time of 10 second (peak top).

### (Fabrication of Specimen)

Testers conducted the following procedure. Laser welding was performed, while an end of the bottom surface of a discharge member was in contact with an end of the bottom surface of a base member formed of a rectangular parallel-piped (bottom surface width: 2.7 mm, and height: 1.3 mm), to thereby yield specimens of samples Nos. 1 to 68. In each specimen, the base member was joined to the discharge member by the mediation of the fusion zone. The material of the base member was a nickel-base alloy NCF601. In the case of sample No. 61, laser output was controlled to fall within a range of 10 to 50 W in laser welding. By tuning the laser output or the target position of the laser beam, the Vickers hardness of the fusion zone in a specimen was modulated. Thus, in each of the cases of samples Nos. 1 to 68, there were provided two specimens each including a discharge member and a fusion zone having different Vickers hardness values.

Each specimen of samples Nos. 1 to 68 was embedded in epoxy resin, and a test surface was obtained by polishing a cross-section including a straight line passing through the center of the bottom surface of the discharge member (i.e., a straight line orthogonal to the bottom surface). The presence of cracking in the discharge member and the fusion zone was checked by observing the test surface under a metallurgical microscope.

### (Measurement of Vickers Hardness)

After checking of cracking of a specimen, the Vickers hardness of the specimen was determined on the basis of JIS Z2244-1:2020. Specifically, an indenter was pressed against the test surface of the fusion zone and that of the discharge member at test force of 500 N for 10 seconds. The Vickers hardness M of the fusion zone was obtained by averaging the Vickers hardness values at 30 points selected at random in the test surface of the fusion zone, and the Vickers hardness D of the discharge member was obtained by averaging the Vickers hardness values at 30 points selected at random in the test surface of the discharge member. The Vickers hardness M of the fusion zone was divided by the Vickers hardness D of the discharge member, to thereby obtain an M/D value.

### (Cooling/Heating Cycle Test)

To a center electrode to which one specimen of samples Nos. 1 to 68 was connected, and the outer surface of an insulator to which a terminal metal fitting was disposed, a metallic shell connected to a ground electrode was attached. By bending the ground electrode, a spark gap was provided between the ground electrode and the discharge member of the center electrode, to thereby yield a spark plug sample. The spark plug samples formed of the same material and having the same dimensions were provided, except those of the specimen portion.

Testers conducted the following cooling/heating cycle test. Each sample was set in a 4-cylinder, direct injection 2000 cc engine provided with a supercharger. The engine was operated at 5,000 rpm for 1 minute, and then at 800 rpm for 1 minute. The sequential operation was repeated to a total operation time of 100 hours.

After the cooling/heating cycle test, each sample of the test pieces was embedded and fixed in epoxy resin, and a cross-section including a straight line passing through the centroid of the bottom surface of the discharge member (i.e., a straight line orthogonal to the bottom surface) was polished. The presence of cracking in the discharge member and the fusion zone was checked by observing the test surface under a metallurgical microscope.

In the case where cracking was observed in a sample after laser welding, the sample was evaluated as “C.” In the case where no cracking was observed in a sample after laser welding, but cracking was observed after the heating/cooling cycle test, the sample was evaluated as “B.” In the case where no cracking was observed in a sample after laser welding and after the heating/cooling cycle test, the sample was evaluated as “A.”

TABLES 1 and 2 show chemical components of discharge members of samples Nos. 1 to 68, Vickers hardness values M and D, M/D, evaluation scores. In any chemical compositions of the sample, the balance (Bal.) is Ru, and the proportions (mass %) of additional elements (excluding impurity) other than Ru are shown in TABLES 1 and 2.

TABLE 1

| | | | | | | | | | | | | | | VICKERS | | | |
|---|---|---|---|---|---|---|---|---|---|---|---|---|---|---|---|---|---|
| | CHEMICAL COMPONENTS (MASS %) | | | | | | | | | | | | | HARDNESS (HV) | | | |
| No. | Pt | Ir | Rh | Re | Pd | Au | Al | Co | Ni | Cr | Si | Y₂O₃ | Ru | M* | D** | M/D | SCORE |
| 1 | 5.0 | | | | | | | | | | | | Bal. | 126 | 525 | 0.24 | C |
| 2 | 27.0 | | | | | | | | | | | | Bal. | 126 | 503 | 0.25 | B |
| 3 | 20.0 | | | | | | | | | | | | Bal. | 137 | 456 | 0.30 | B |
| 4 | 15.0 | | | | | | | | | | | | Bal. | 180 | 336 | 0.54 | B |
| 5 | 6.0 | | | | | | | | | | | | Bal. | 237 | 424 | 0.56 | B |
| 6 | 5.0 | | | | | | | | | | | | Bal. | 201 | 342 | 0.59 | B |
| 7 | 23.0 | | | | | | | | | | | | Bal. | 241 | 395 | 0.61 | B |
| 8 | 15.0 | | | | | | | | | | | | Bal. | 248 | 397 | 0.62 | B |
| 9 | 15.0 | | | | | | | | | | | | Bal. | 201 | 319 | 0.63 | B |
| 10 | | | | | | | 5.0 | | | | | | Bal. | 310 | 468 | 0.66 | B |
| 11 | 17.0 | | | | | | | | | | | | Bal. | 312 | 456 | 0.68 | B |
| 12 | 28.0 | | | | | | | | | | | | Bal. | 186 | 265 | 0.70 | B |
| 13 | | | | | | | | | 15.0 | | | | Bal. | 234 | 327 | 0.72 | B |
| 14 | 25.0 | | | | | | | | | | | | Bal. | 203 | 264 | 0.77 | B |
| 15 | 22.0 | | | | | | | | | | | | Bal. | 302 | 368 | 0.82 | B |
| 16 | 11.0 | | | | | | | | | | | | Bal. | 198 | 240 | 0.83 | B |
| 17 | | | | | | | | | | | 1.0 | | Bal. | 255 | 300 | 0.85 | B |
| 18 | 30.0 | | | | | | | | | | | | Bal. | 295 | 339 | 0.87 | B |
| 19 | 2.0 | | | | | | | | | | | | Bal. | 281 | 320 | 0.88 | B |
| 20 | | | | | | | | | | 3.0 | | | Bal. | 291 | 325 | 0.90 | B |
| 21 | | | | | | | | | 5.0 | | | | Bal. | 298 | 331 | 0.90 | B |
| 22 | | | | | | | 1.0 | | | | | | Bal. | 320 | 351 | 0.91 | B |
| 23 | | | | | | | | 13.0 | | | | | Bal. | 359 | 381 | 0.94 | B |
| 24 | 9.0 | | | | | | | | | | | | Bal. | 301 | 315 | 0.96 | B |
| 25 | | | | | | | | 10.0 | | | | | Bal. | 387 | 405 | 0.96 | B |
| 26 | 21.0 | | | | | | | | | | | | Bal. | 455 | 470 | 0.97 | B |
| 27 | 5.0 | | | | | | | | | | | | Bal. | 273 | 280 | 0.98 | B |
| 28 | | | | | | 1.0 | | | | | | | Bal. | 230 | 233 | 0.99 | B |
| 29 | 5.0 | | | | | | | | | | | | Bal. | 309 | 308 | 1.00 | B |
| 30 | | | | | | 10.0 | | | | | | | Bal. | 370 | 367 | 1.01 | B |
| 31 | 7.0 | | | | | | | | | | | | Bal. | 292 | 287 | 1.02 | B |
| 32 | 26.0 | | | | | | | | | | | | Bal. | 426 | 411 | 1.04 | B |
| 33 | 24.0 | | | | | | | | | | | | Bal. | 293 | 282 | 1.04 | B |
| 34 | | 5.0 | | | | | | | | | | | Bal. | 520 | 493 | 1.05 | A |
| 35 | 15.0 | | | | | | | | | | | 3.0 | Bal. | 347 | 329 | 1.05 | A |
| 36 | | | | | 11.0 | | | | | | | | Bal. | 520 | 480 | 1.08 | A |
| 37 | | 15.0 | | | | | | | | | | | Bal. | 439 | 405 | 1.08 | A |
| 38 | | | 1.0 | | | | | | | | | | Bal. | 440 | 401 | 1.10 | A |
| 39 | 18.0 | | | | | | | | | | | | Bal. | 538 | 488 | 1.10 | A |
| 40 | 29.0 | | | | | | | | | | | | Bal. | 266 | 232 | 1.15 | A |
| 41 | 13.0 | | | | | | | | | | | | Bal. | 546 | 469 | 1.16 | A |
| 42 | 5.0 | | | | | | | | | | | | Bal. | 486 | 417 | 1.17 | A |
| 43 | 12.0 | | | | | | | | | | | | Bal. | 575 | 491 | 1.17 | A |
| 44 | 30.0 | | | | | | | | | | | | Bal. | 395 | 336 | 1.18 | A |
| 45 | | | | 8.0 | | | | | | | | | Bal. | 456 | 387 | 1.18 | A |

M*: FUSION ZONE
D**: DISCHARGE MEMBER

TABLE 2

| | | | | | | | | | | | | | | VICKERS | | | |
|---|---|---|---|---|---|---|---|---|---|---|---|---|---|---|---|---|---|
| | CHEMICAL COMPONENTS (MASS %) | | | | | | | | | | | | | HARDNESS (HV) | | | |
| No. | Pt | Ir | Rh | Re | Pd | Au | Al | Co | Ni | Cr | Si | Y₂O₃ | Ru | M* | D** | M/D | SCORE |
| 46 | | | | | 7.0 | | | | | | | | Bal. | 498 | 412 | 1.21 | A |
| 47 | 16.0 | | | | | | | | | | | | Bal. | 354 | 288 | 1.23 | A |
| 48 | | | | 5.0 | | | | | | | | | Bal. | 378 | 306 | 1.24 | A |
| 49 | 32.0 | | | | | | | | | | | | Bal. | 518 | 415 | 1.25 | A |
| 50 | 0.4 | | | | | | | | | | | | Bal. | 507 | 406 | 1.25 | A |
| 51 | 4.0 | | | | | | | | | | | | Bal. | 301 | 239 | 1.26 | A |
| 52 | | | 13.0 | | | | | | | | | | Bal. | 406 | 322 | 1.26 | A |
| 53 | 30.0 | | | | | | | | | | | | Bal. | 545 | 419 | 1.30 | A |
| 54 | 31.0 | | | | | | | | | | | | Bal. | 424 | 322 | 1.32 | A |
| 55 | 30.0 | | | | | | | | | | | | Bal. | 368 | 279 | 1.32 | A |
| 56 | 33.0 | | | | | | | | | | | | Bal. | 407 | 301 | 1.35 | A |
| 57 | 15.0 | | | | | | | | | | | | Bal. | 618 | 456 | 1.36 | A |
| 58 | 14.0 | | | | | | | | | | | | Bal. | 617 | 441 | 1.40 | A |
| 59 | 1.0 | | | | | | | | | | | | Bal. | 620 | 438 | 1.42 | A |
| 60 | 30.0 | | | | | | | | | | | | Bal. | 462 | 324 | 1.43 | A |
| 61 | 10.0 | | | | | | | | | | | | Bal. | 604 | 376 | 1.61 | A |
| 62 | 3.0 | | | | | | | | | | | | Bal. | 395 | 234 | 1.69 | A |
| 63 | | | | | 9.0 | | | | | | | | Bal. | 422 | 236 | 1.79 | A |
| 64 | 19.0 | | | | | | | | | | | | Bal. | 435 | 234 | 1.86 | A |
| 65 | 15.0 | | | | | | | | | | | | Bal. | 520 | 226 | 2.30 | A |
| 66 | 5.0 | | | | | | | | | | | | Bal. | 558 | 223 | 2.50 | A |
| 67 | 8.0 | | | | | | | | | | | | Bal. | 616 | 220 | 2.80 | A |
| 68 | 30.0 | | | | | | | | | | | | Bal. | 580 | 200 | 2.90 | C |

M*: FUSION ZONE
D**: DISCHARGE MEMBER

As shown in TABLES 1 and 2, sample No. 1 (M/D: 0.24) and sample No. 68 (M/D: 2.90) were evaluated as score C. Conceivably, reduction of deformation of the discharge member by deformation of the fusion zone was not achieved, and tensile stress is applied to the discharge member due to rapid heating or cooling in welding and contraction of the fusion zone, to thereby evoke cracking of the discharge member.

In contrast, samples Nos. 2 to 67 (M/D: 0.25 or greater and 2.80 or smaller) were evaluated as score A or B. Conceivably, the tensile stress of the discharge member, which stress would otherwise be caused by rapid heating or cooling in welding and contraction of the fusion zone, is mitigated by the fusion zone, whereby cracking of the discharge member or the fusion zone is inhibited during welding.

Particularly, samples Nos. 34 to 67 (M/D: 1.05 or greater and 2.80 or smaller) were evaluated as score A. Thus, there has been elucidated that no cracking occurs in the discharge member or the fusion zone possibly caused by thermal impact in the heating/cooling cycle test, when the value of M/D falls within the above range.

Actually, samples Nos. 34 to 67 evaluated as score A contained, in addition to Ru, an element selected from the group consisting of Ir, Pt, Rh, Re, and Pd. Conceivably, the score A was realized through enhancement in strength of the fusion zone via formation of solid solution with any of the additional elements.

Although the present invention has been described on the basis of an embodiment, it can be easily surmised that the present invention is not limited to the above-described embodiment, and various improvements and modifications can be made without departing from the purpose of the present invention.

In the embodiment, the center electrode 13 is shown as an example of the first electrode, and the ground electrode 19 is shown as an example of the second electrode. However, the present invention is not limited to such a configuration. Of course, it is possible to use the ground electrode 19 as the first electrode and use the center electrode 13 as the second electrode. In this case, the discharge member 21 (the main component: Ru) is fixed to the base member 20 (the main component: Ni) of the ground electrode 19 via the fusion zone 22, and the value obtained by dividing the Vickers hardness of the fusion zone 22 by the Vickers hardness of the discharge member 21 is set to fall within the range of 0.25 to 2.8, inclusive.

In the embodiment, there has been described the case where the ground electrode 19 has the bent base member 20. However, the present invention is not limited to such a configuration. Of course, it is possible to use a straight base member Instead of the bent base member 20. In this case, a forward end portion of the metallic shell 18 is extended in the axial direction, and the straight base member is connected to the metallic shell 18 such that the ground electrode 19 faces the center electrode 13. The number of the ground electrode(s) 19 may be freely set.

In the embodiment, there has been described the case where the ground electrode 19 is disposed such that the discharge member 15 faces the ground electrode 19 in the axial direction. However, the present invention is not limited to such a configuration, and the positional relation between the ground electrode 19 and the center electrode 13 may be freely set. The ground electrode 19 and the center electrode 13 may have a different positional relation therebetween, for example, the ground electrode 19 may be disposed such that the ground electrode 19 faces the side surface of the discharge member 15 of the center electrode 13.

In the embodiment, there has been described the case where the discharge member 21 is fixed to a surface of the base member 20 of the ground electrode 19, which surface faces toward the rear end side. However, the present invention is not limited to such a configuration. The discharge member 21 may be fixed to any surface of the base member 20 so long as the spark gap 24 is defined between the discharge member 21 and the center electrode 13. Of course, it is possible to omit the discharge member 21 of the ground electrode 19.

### REFERENCE SIGNS LIST

10: spark plug
13: center electrode (first electrode)
14: base member
15: discharge member
16: fusion zone
19: ground electrode (second electrode)
24: spark gap

1. A spark plug comprising
a first electrode which has a discharge member joined to a base member containing Ni as a main component by the mediation of a fusion zone, and
a second electrode facing the discharge member with a spark gap therebetween,
the discharge member containing Ru as a main component, wherein
a value obtained by dividing Vickers hardness of the fusion zone by Vickers hardness of the discharge member is 0.25 or greater and 2.8 or smaller.

2. A spark plug according to claim 1, wherein
the discharge member contains one or more elements selected from the group consisting of Ir, Pt, Rh, Re, Pd, Mo, W, Au, Al, Co, Ni, Cr, and Si.

3. A spark plug according to claim 1, wherein
the value is 1.05 or greater and 2.8 or smaller.

4. A spark plug according to claim 3, wherein
the discharge member contains one or more elements selected from the group consisting of Ir, Pt, Rh, Re, Pd, Mo, and W.
